(19) United States
(12) Patent Application Publication
(10) Pub. No.: US 2006/0166697 A1
(43) Pub. Date: Jul. 27, 2006

(54) Wireless communication device capable of automatically sending a message and method of the same

(75) Inventors: Cheng-Shing Lai, Taipei (TW); Jias-Heng Mei, Nanking City (CN); Xiao-Long Fan, Nanking City (CN)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/041,960

(22) Filed: Jan. 26, 2005

(51) Int. Cl. H04M 1/00

(52) U.S. Cl. 455/550.1

(57) ABSTRACT

A wireless communication device capable of sending a message and a method of automatically sending a message are disclosed. The wireless communication device comprises a message inputting interface inputting a message to the device, a setting module setting data corresponding to the message, wherein the data comprises a predetermined time and a predetermined telephone number, a timer clocking time and a scheduling module detecting if the predetermined time reaches according to the timer. Wherein, when the predetermined time is detected, the message is sent by the receiving/transmitting module.

### BACKGROUND OF THE INVENTION

1. Field of Invention

The present invention relates to a wireless communication device capable of sending a message and a method of sending a message, and particularly to a wireless communication device of automatically sending a message according to a predetermined time and a telephone number and a method of automatically sending a message.

2. Related Art

With prevalence of the wireless communication device such as a mobile phone, information communication has become more and more frequently and widely used. The wireless communication device not only provides the communication function but also other applications such as a messaging function. Nowadays, the messaging function has become a convenient added-value application of the wireless communication device.

The messaging function has its necessity. For example, in the case that a person is engaged in business but would like to tell a receiver “Happy Birthday!”, the person may just send a message saying “Happy Birthday!” to the receiver and appropriately achieve the greeting purpose. As another example, “Be punctual to attend the meeting held in 3:00.” is also a message which may be often used. Therefore, a message may not only achieve results of delivering information to the other end and saving cost, but also avoid possible unhappiness occurred in an oral communication through the wireless communication device.

Referring to FIG. 1, a schematic illustration of a message sending scheme using a prior wireless communication device is depicted therein. As shown, the wireless communication device 1 has a transmitting/receiving module 2 used to transmit/receive information. An information inputting interface 4 comprises a key set 5 and a display panel 6 through which a user 3 may input message information. Specifically, the user 3 inputs the message information by use of the key set 5 and displays his keyed message information through the display panel 6 to know if the information is correctly keyed. After the information is inputted through the information inputting interface 4, the information is sent by the transmitting/receiving module 2 to another communication device 7 the user 3 desires to send to. By way of this, a user 8 of the receiving-end communication device 7 may receive the information as sent from the wireless communication device 1.

Although the messaging function provides a convenient message information sending mechanism, a user of such wireless communication device may possibly forget and be delayed to send messages, of which there may be some important messages which may cause a break in affection or a loss in business.

Therefore, there is a need of providing a wireless communication capable of automatically sending a message and a method of automatically sending a message.

### SUMMARY OF THE INVENTION

It is, therefore, an object of the present invention to provide a wireless communication device capable of automatically sending a message and a method of automatically sending a message according to a predetermined time and a predetermined telephone number, wherein the message comprises a message stored in a calendar or a short message stored in a memory module in the wireless communication device. Alternatively, the wireless communication device may automatically link communicatively to a communication device corresponding to the pre-determined telephone number according to the predetermined time and the predetermined telephone number to communicate with each other.

To achieve the above object, the wireless communication device capable of automatically sending a message comprises a message input interface inputting a message to a memory module in the device, a setting module setting data corresponding to the message, wherein the data comprises a predetermined time and a predetermined telephone number, a timer clocking time and a scheduling module detecting if the predetermined time has reached according to the timer.

When the predetermined time is reached according to the timer, a dialing interface of the wireless communication device dials the predetermined telephone number corresponding to the predetermined time and the communication receiving/transmitting module transmits the message corresponding to the predetermined time to a communication device corresponding to the predetermined telephone number.

Therefore, a message may be automatically sent to a predetermined communication device at a predetermined time by use of the wireless communication device capable of automatically sending a message and the method of automatically sending a message according to the present invention, wherein the message may be a message stored in a calendar or a short message stored in a memory module in the wireless communication device. Additionally, the wireless communication device may automatically link communicatively to a communication device corresponding to the predetermined telephone number according to the predetermined time and the predetermined telephone number to communicate with each other. Therefore, the user may efficiently send a message to a receiver in a punctual and convenient manner.

The advantages and spirits of the present invention may be further understood with reference to the following description and the accompanying drawings.

### BRIEF DESCRIPTION OF THE DRAWINGS

The invention will become more fully understood from the detailed description given hereinbelow illustration only, and thus are not limitative of the present invention, and wherein:

FIG. 1 is a schematic diagram illustrating a prior message sending technology;

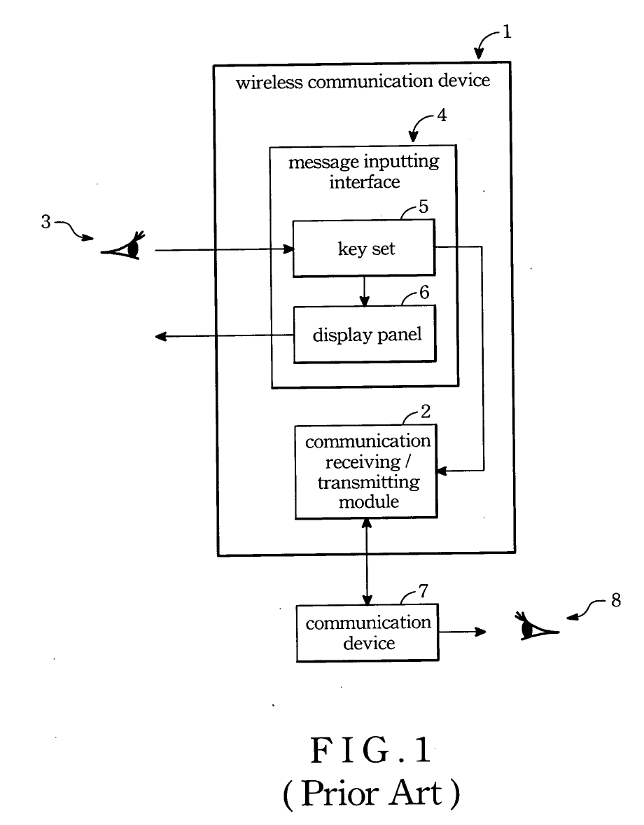

FIG. 2 is a schematic diagram illustrating a wireless communication device according to the present invention;

FIG. 3 is a schematic diagram of a message inputting interface according to the present invention

FIG. 4 is a flowchart of a method of automatically sending a message using the device shown in FIG. 2;

FIG. 5 is a flow chart of an editing process of the method depicted in FIG. 4; and

FIG. 6 us a flow chart of an automatic sending process of the method depicted in FIG. 4.

### DETAILED DESCRIPTION OF THE INVENTION

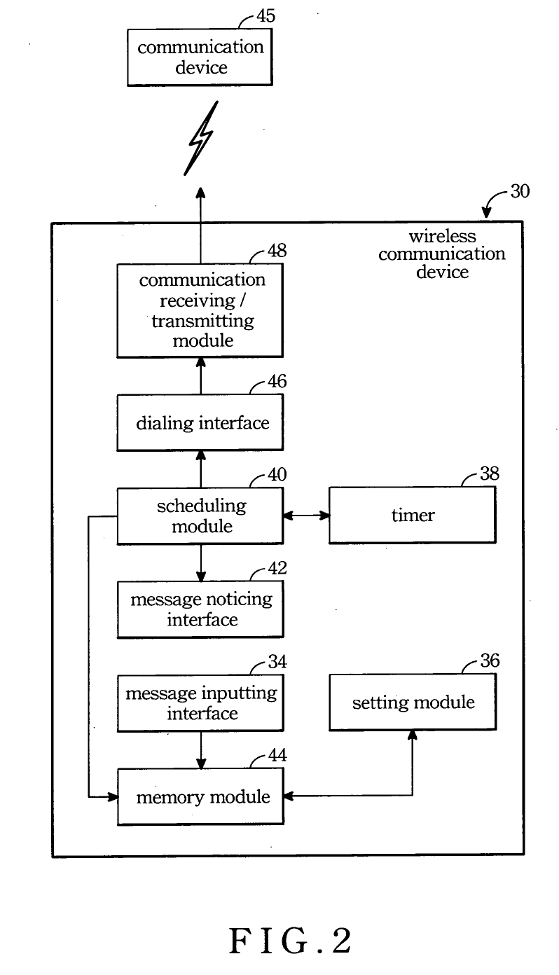

Referring to FIG. 2, a wireless communication device 30 is illustrated therein. As shown, the wireless communication device 30 capable of automatically sending a message comprises a message inputting interface 34, a setting module 36, a timer 38, a scheduling module 40 and a message noticing interface 42.

The message inputting interface 34 is used to input the message into the memory module 44 in the wireless communication device 30. The setting module 36 is used to set data associated with the message such as a predetermined time and a predetermined telephone number. Namely, the predetermined time and telephone number corresponding to the message is set through the setting module 36. The timer 38 is used to clock time. The scheduling module 40 detects if the predetermined time reaches according to the time clocked by the timer 38. Upon the predetermined time reached, the message noticing interface 42 notices a user of the wireless communication device 30 that the message corresponding to the predetermined time will be sent and the dialing interface 46 dials the telephone number corresponding to the message. Through the communication receiving/transmitting module 48, the wireless communication device 30 is communicatively connected to another communication device 45 corresponding to the predetermined telephone number and send the message to the communication device 45.

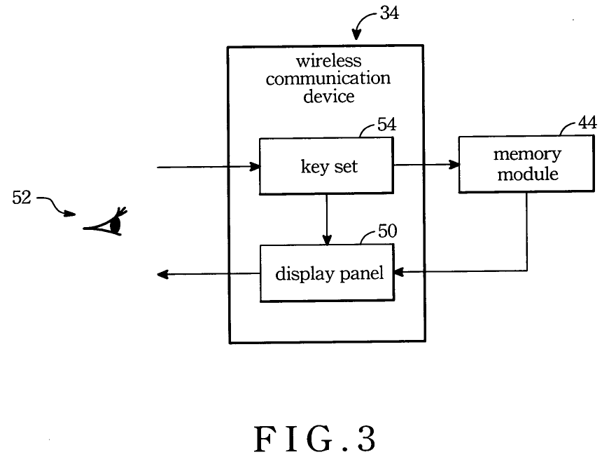

Referring to FIG. 3, a message inputting interface 34 in the wireless communication device 30 according to the present invention is schematically illustrated therein. As shown, the message inputting interface 34 comprises a key set 54 and a display panel 50, wherein the key set 54 is used for the user 53 to input the message to the wireless communication device 30 in the memory module 44 and the display panel 50 is used to show the edited message to the user 52.

In addition, information provided by the message noticing interface 42 is also displayed to the user 52 through the display panel 50. Alternatively or additionally, the message noticing interface 42 may further provide a sound to notice the user 52 that the message will be sent. Or, the message noticing interface 42 may flicker the frame of the display panel 50 and/or change the color on the display panel 50 to achieve the noticing function.

The message sent to the communication device 45 corresponding to the predetermined telephone number in the manner as mentioned above is a short message. The short message may be a message stored in the calendar in the wireless communication device 30 or a short message stored in a memory module 44 in the wireless communication device 30.

Additionally, the wireless communication device 30 may also automatically link communicatively to the communication device 45 corresponding to the telephone number so that the user 52 may communicate directly with the one corresponding to the communication device 45. In using this direct communication mode, the message noticing interface 42 has to notice the user 52 that a communication with the one corresponding to the predetermined telephone number will begin so that the user 52 may get ready to communicate with the one corresponding to the communication device 45 when the communication device 45 is answered.

After the receiving/transmitting module 38 sends the message to the communication device 45, the setting module 36 will delete the message and data associated with the message if the corresponding predetermined time will not come again. For example, if the predetermined time is Dec. 25, 1999 at 17:00 p.m., the predetermined time is deleted by the setting module 36.

If the predetermined time will occur again, then the predetermined is maintained by the setting module 36. For example, since the predetermined time of 8:00 a.m. every Sunday will occur periodically, the time is maintained and the message corresponding to the predetermined time will be sent periodically according to the predetermined time.

The function of automatically sending a message achieved by the message scheduling module 34, the message inputting interface 34, setting module 36, a timer 38, a scheduling module 40 and the like may also be achieved by the calendar and the communication receiving/transmitting module in the wireless communication device 30. In this case, the setting module 36 in the wireless communication device 30 needs additionally a pack of software exclusively for a predetermined telephone number.

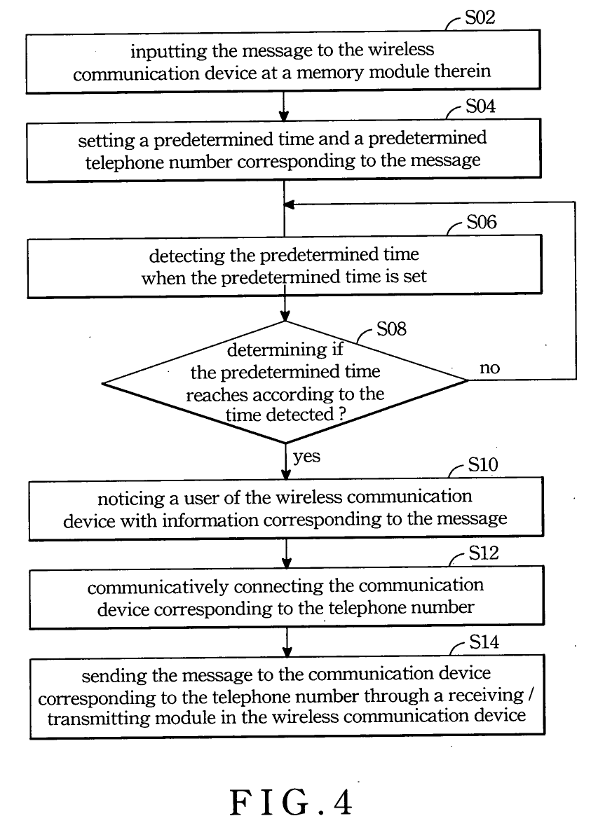

Referring to FIG. 4, a flowchart of a method of automatically sending a message according to the present invention is illustrated therein which is executed in the wireless communication device capable of automatically sending a message according to the present invention. The method comprises the following steps:

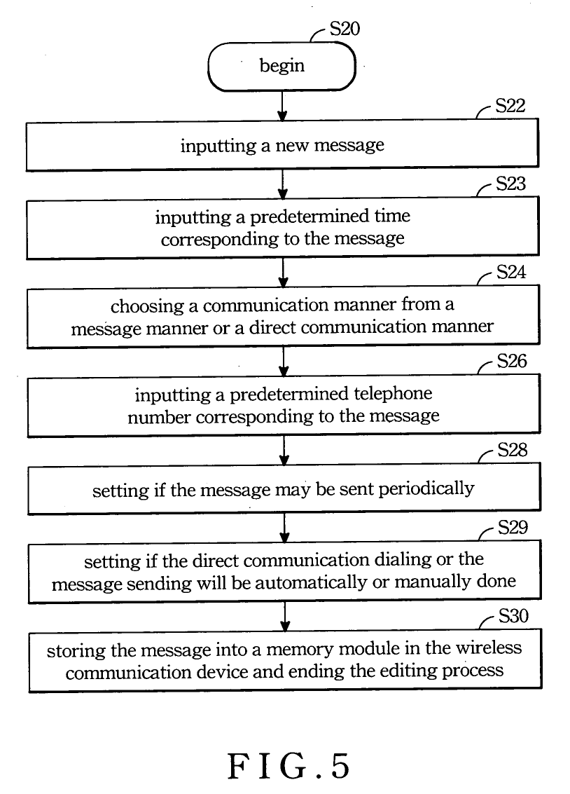

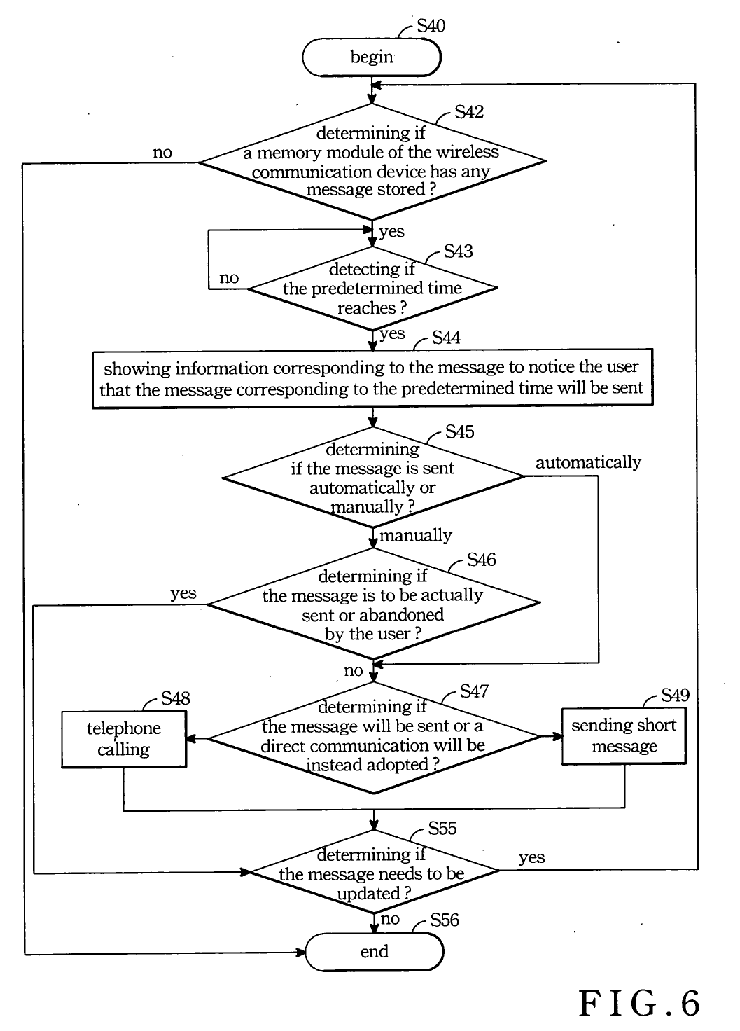

First, the message is inputted to the wireless communication device 30 at a memory module 44 therein (S02). Next, data associated with the message is set, such as a predetermined time and a predetermined telephone number corresponding to the message (S04). When the predetermined time is set, the predetermined time is detected continuously (S06). Then, determining if the predetermined time reaches according to the time detected (S08). If the predetermined time reaches, noticing a user of the wireless communication device with information corresponding to the message (S10). Simultaneously, dialing the telephone number corresponding to the message to communicatively connect to the communication device corresponding to the telephone number (S12). Thereafter, sending the message to the communication device corresponding to the telephone number through a receiving/transmitting module in the wireless communication device (S14). The method of automatically sending a message as described above actually comprises an editing process and an automatic sending process. The editing and automatic sending processes will be described as follows with reference to FIG. 5 and FIG. 6 respectively. Referring to FIG. 5, the editing process begins (S20). Next, inputting a new message (S22). Inputting a predetermined time corresponding to the message (S23). Next, choosing a communication manner from a message manner or a direct communication manner (S24). Inputting a predetermined telephone number corresponding to the message (S26). Next, setting if the message may be sent periodically (S28). If the predetermined time contains a field corresponding to “year”, the predetermined time may not periodically occur again after it is occurred once. If the predetermined time only contains fields corresponding to “month”, “day”, “week”, “hour” or the like, the predetermined time may be set and the corresponding message may be sent based on a periodical manner. Next, setting if the direct communication dialing or the message sending will be automatically or manually done (S29). Finally, storing the message into a memory module in the wireless communication device and the editing process ends(S30).

Referring to FIG. 6, the automatically sending process of the method of automatically sending a message according to the present invention is illustrated therein. The process begins (S40). Determining if a memory module of the wireless communication device has any message stored (S42). If not, the process ends (S56). If yes, detecting if the predetermined time reaches (S43). If the detecting result is “yes”, a message noticing interface shows information corresponding to the message to notice the user that the message corresponding to the predetermined time will be sent (S44). Next, determining if the message is sent automatically or manually (S45). If it is determined the message will be sent automatically, then determining if the short message will be sent (S49) or a direct communication (S48) will be instead adopted (S47). If the message is determined to be sent manually in step 45, determining if the message is to be actually sent or abandoned by the user (S46). If it is determined to abandon the message sending, determining if the message needs to be updated (S55). If it is determined to send the message, the process jumps to the step 47. After the step 47, the process goes back to the step 55. If the updating operation is ascertained in step 55, the process goes back to the step 42. If not, the process ends (56).

Through the wireless communication device capable of automatically sending a message and the method of automatically sending a message according to the present invention, a message may be sent to a predetermined communication device automatically, wherein the message may be a message stored in the calendar or a short message stored in the memory module in the communication device. Alternatively, a direct communication with the user of the predetermined communication device may be provided in replace of the message sending. Therefore, the message may be sent in a punctual and convenient manner.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

1. A wireless communication device capable of automatically sending a message, comprising:
a receiving/transmitting module transmitting a message from the wireless communication device;
a message inputting interface inputting a message to a memory module in the wireless communication device;
a setting module setting data corresponding to the message, wherein the data comprises a predetermined time and a predetermined telephone number corresponding to a communication device the message is intent to be sent to;
a timer clocking time; and
a scheduling module detecting if the predetermined time has reached according to the time clocked by the timer,
wherein when the predetermined time is detected, the message is sent by the receiving/transmitting module.

2. The wireless communication device as recited in claim 1, further comprising a message noticing interface providing information corresponding to the message to a user of the wireless communication device when the predetermined time is detected.

3. The wireless communication device as recited in claim 1, wherein the setting module deletes the message and the data corresponding to the message if the predetermined time corresponding to the message may not occur again after the message is sent to the communication device corresponding to the telephone number.

4. The wireless communication device as recited in claim 1, wherein the setting module maintains the message and the data corresponding to the message if the predetermined time corresponding to the message may occur again after the message is sent to the communication device corresponding to the telephone number.

5. A method of automatically sending a message using a wireless communication device, comprising the steps of:
inputting the message to a memory module of the wireless communication device;
setting data corresponding to the message by a setting module in the wireless communication device, wherein the data corresponding to the message comprises a predetermined time and a predetermined telephone number corresponding to a communication device;
detecting if the predetermined time reaches by a scheduling module in the wireless communication device; and
sending the message to the communication device corresponding to the predetermined telephone number when the predetermined time reaches as detected.

6. The method as recited in claim 5, further comprising a step of noticing a user of the wireless communication device with information corresponding to the predetermined time when the predetermined time is detected.

7. The method as recited in claim 5, wherein the setting module deletes the message and the data corresponding to the message if the predetermined time corresponding to the message may not occur again after the message is sent to the communication device corresponding to the telephone number.

8. The method as recited in claim 5, wherein the setting module deletes the message and the data corresponding to the message if the predetermined time corresponding to the message may not occur again after the message is sent to the communication device corresponding to the telephone number.
